(19) United States
(12) Patent Application Publication
(10) Pub. No.: US 2004/0076908 A1
(43) Pub. Date: Apr. 22, 2004

(54) Phase change optical recording medium

(75) Inventors: Noritake Oomachi, Yokohama-shi (JP); Katsutaro Ichihara, Yokohama-shi (JP); Keiichiro Yusu, Yokohama-shi (JP); Sumio Ashida, Tokyo (JP); Naomasa Nakamura, Yokohama-shi (JP); Takayuki Tsukamoto, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/678,450

(22) Filed: Oct. 6, 2003

(30) Foreign Application Priority Data
Oct. 18, 2002 (JP) 2002-304735

(51) Int. Cl. G11B 7/24

(52) U.S. Cl. 430/270.13; 369/275.2; 369/275.5; 430/945

(57) ABSTRACT

A phase change optical recording medium according to an embodiment of this invention includes a substrate, a reflecting layer which reflects a light beam, a phase change recording layer which is arranged between the substrate and the reflecting layer and changes between a crystalline state and an amorphous state when irradiated with the light beam, a first dielectric layer which is arranged between the substrate and the reflecting layer, and a second dielectric layer which is arranged between the substrate and the first dielectric layer and has a thermal conductivity lower than that of the first dielectric layer.

### CROSS-REFERENCE TO RELATED APPLICATIONS

This application is based upon and claims the benefit of priority from the prior Japanese Patent Application No. 2002-304735, filed Oct. 18, 2002, the entire contents of which are incorporated herein by reference.

### BACKGROUND OF THE INVENTION

1. Field of the Invention

The present invention relates to a phase change optical recording medium having a phase change recording layer which changes between a crystalline state and an amorphous state when irradiated with a light beam.

2. Description of the Related Art

Phase change optical recording media are readily overwritten by light intensity modulation using a single beam because of their recording principle and also are readily compatible with ROM media because of the reproduction principle. For these reasons, the phase change optical recording media are used for a CD-RW, DVD-RAM, DVD-RW, and the like. That is, the phase change optical recording media are widely put into practical use in the field of computer files and image/audio files. For the phase change optical recording media, performance is expected to improve and, more particularly, the storage capacity is expected to increase.

The storage capacity of a phase change recording medium can be increased by shortening the wavelength of a light source, increasing the numerical aperture of an objective lens, improving the modulation/demodulation technique, improving the format efficiency, or improving the medium. For next-generation DVDs that use a blue laser having a wavelength of about 400 nm, proposals have been made to increase the numerical aperture (NA) (NA: 0.85) or attach importance to compatibility to the numerical aperture (NA: 0.6) of current DVDs (NA: about 0.65). In addition, to increase the capacity of phase change recording, various proposals have been made in association with the medium film structures and materials suitable for mark length recording or land/groove (L/G) recording.

The structure of a basic phase change optical recording medium will be described here. A basic phase change optical recording medium typically has a four-layered structure. The four-layered structure is obtained by forming a first interference layer represented by ZnS—SiO₂, a phase change recording layer represented by GeSbTe or AgInSbTe, a second interference layer represented by ZnS—SiO₂, and a reflecting layer represented by an Al alloy or Ag alloy and also serving as a heat sink sequentially from the light incident side. The phase change recording layer is amorphous as an as-deposited film. This amorphous state has a higher energy than that in an amorphous state formed by optical recording and hardly changes to a crystal. For this reason, the medium is used normally after initial crystallization is performed using a bulk initializer or the like. The reflectance of a crystalline portion is defined as Rc. The reflectance of an amorphous portion is defined as Ra. If the reflectance Rc is too low, the reproduction signal quality in the header field may be poor. In addition, the servo signal in the initial state may be unstable. For these reasons, a conventional phase change optical disk is normally optically designed such that Rc>Ra. Additionally, to increase the light utilization efficiency and thus obtain a high recording sensitivity, the reflecting layer is normally set to have a thickness that hardly transmits light. Hence, the transmittance of the entire medium is almost zero. The absorption index when the phase change recording layer is in the crystalline state is defined as Ac. The absorption index when the phase change recording layer is in the amorphous state is defined as Aa. When Rc>Ra is designed, Ac<Aa.

To execute overwrite recording, it is important to record marks with the same size on both the crystalline portion and the amorphous portion by the same recording power. The latent heat that is required to fuse the crystalline portion is larger than the latent heat that is required to fuse the amorphous portion. Hence, in the medium that satisfies Ac<Aa, the size of a fused portion that is formed by irradiating the crystalline portion with a recording beam is smaller than the size of a fused portion that is formed by irradiating the amorphous portion with the recording beam. This increases the overwrite jitter. Especially, in mark length recording suitable for a high linear density, more overwrite jitter is a serious problem.

To solve the problem of jitter, various proposals have been done. For example, Jpn. Pat. Appln. KOKAI Publication No. 2002-157737 proposes an optical recording medium in which a transparent substrate, high-thermal-conductivity dielectric layer, low-thermal-conductivity dielectric layer, and recording layer are formed sequentially from the light incident side.

An effective method of increasing the track density is L (Land)/G (Groove) recording described above. In the L/G recording technique, the depth of a groove is set to about ⅙ of the wavelength. The phase difference between the crystalline state and the amorphous state of the phase change recording layer is decreased. This largely reduces crosstalk and increases the track density. In addition, groove steps are present between lands and grooves. Since thermal conduction in the in-plane direction of the recording layer is suppressed, a cross erase reduction effect can also be obtained. Cross erase occurs not only due to thermal conduction in the in-plane direction of the recording layer but also due to direct heating of adjacent tracks by beam edges. In the above-described “Ac>Aa” structure, the value Aa itself is smaller than that in an “Ac<Aa” structure. For this reason, any increase in temperature of amorphous recording marks on adjacent tracks is suppressed. It is advantageous in reducing cross erase.

However, in the optical recording medium proposed in the above prior art, a new problem may be posed. That is, the substrate that is in contact with the high-thermal-conductivity dielectric layer easily deforms or deteriorates by the influence of heat transmitted to the high-thermal-conductivity dielectric layer.

In addition, the conventional cross erase suppressing method is not sufficiently effective should the capacity further increase in the future.

### BRIEF SUMMARY OF THE INVENTION

A phase change optical recording medium according to an aspect of the present invention comprises a substrate, a reflecting layer which reflects a light beam, a phase change recording layer which is arranged between the substrate and the reflecting layer and changes between a crystalline state and an amorphous state when irradiated with the light beam, a first dielectric layer which is arranged between the substrate and the reflecting layer, and a second dielectric layer which is arranged between the substrate and the first dielectric layer and has a thermal conductivity lower than that of the first dielectric layer.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the schematic sectional structure of a phase change optical recording medium having a single-side, single recording layer according to the first embodiment of the present invention;

FIG. 2 is a view showing the schematic sectional structure of a phase change optical recording medium having single-side, multiple recording layers (two layers) according to the first embodiment of the present invention;

FIG. 3 is a view showing the schematic sectional structure of a phase change optical recording medium having a single-side, single recording layer according to the second embodiment of the present invention;

FIG. 4 is a view showing the schematic sectional structure of a phase change optical recording medium having single-side, multiple recording layers (two layers) according to the second embodiment of the present invention;

FIG. 5 is a view showing the schematic sectional structure of a phase change optical recording medium having a single-side, single recording layer according to the third embodiment of the present invention;

FIG. 6 is a view showing the schematic sectional structure of a phase change optical recording medium having single-side, multiple recording layers (two layers) according to the third embodiment of the present invention;

FIG. 7 is a view showing the schematic sectional structure of a phase change optical recording medium having a single-side, single recording layer according to the fourth embodiment of the present invention;

FIG. 8 is a view showing the schematic sectional structure of a phase change optical recording medium having single-side, multiple recording layers (two layers) according to the fourth embodiment of the present invention;

FIG. 9 is a view showing the schematic sectional structure of a phase change optical recording medium having a single-side, single recording layer according to the fifth embodiment of the present invention;

FIG. 10 is a view showing the schematic sectional structure of a phase change optical recording medium having single-side, multiple recording layers (two layers) according to the fifth embodiment of the present invention;

FIG. 11 is a view showing the schematic sectional structure of a phase change optical recording medium having a single-side, single recording layer according to the sixth embodiment of the present invention;

FIG. 12 is a view showing the schematic sectional structure of a phase change optical recording medium having single-side, multiple recording layers (two layers) according to the sixth embodiment of the present invention;

FIG. 13 is a view showing the schematic sectional structure of a phase change optical recording medium having a single-side, single recording layer according to the seventh embodiment of the present invention;

FIG. 14 is a view showing the schematic sectional structure of a phase change optical recording medium having single-side, multiple recording layers (two layers) according to the seventh embodiment of the present invention;

FIG. 15 is a view showing the schematic sectional structure of a phase change optical recording medium having a single-side, single recording layer according to the eighth embodiment of the present invention;

FIG. 16 is a view showing the schematic sectional structure of a phase change optical recording medium having single-side, multiple recording layers (two layers) according to the eighth embodiment of the present invention;

FIG. 17 is a table showing the relationship between materials applicable to a first dielectric layer (high thermal conductivity), thermal conductivities, and preferable layer thicknesses;

FIG. 18 is a table showing the relationship between thermal conductivities and materials applicable to a second dielectric layer (low thermal conductivity);

FIG. 19 is a table showing the relationship between thermal conductivities and materials applicable to an intermediate-thermal-conductivity dielectric layer between the first dielectric layer (high thermal conductivity) and the second dielectric layer (low thermal conductivity);

FIG. 20 is a table showing the evaluation conditions of the recording/reproduction characteristic of the phase change optical recording medium;

FIG. 21 is a table showing the relationship between overwrite and a cross erase (XE) value in a groove track (G) and land track (L);

FIG. 22 is a graph showing a recording/reproduction test result of the phase change optical recording medium and, more particularly, the relationship between the cross erase (XE) value at a track pitch of 0.34 μm and the ratio of a thermal conductivity κ of the first dielectric layer (high thermal conductivity) and that of the second dielectric layer (low thermal conductivity); and

FIG. 23 is a graph showing a result obtained by checking the cross erase (XE) value and the recording sensitivity of the phase change optical recording medium.

### DETAILED DESCRIPTION OF THE INVENTION

The embodiments of the present invention will be described below with reference to the accompanying drawing.

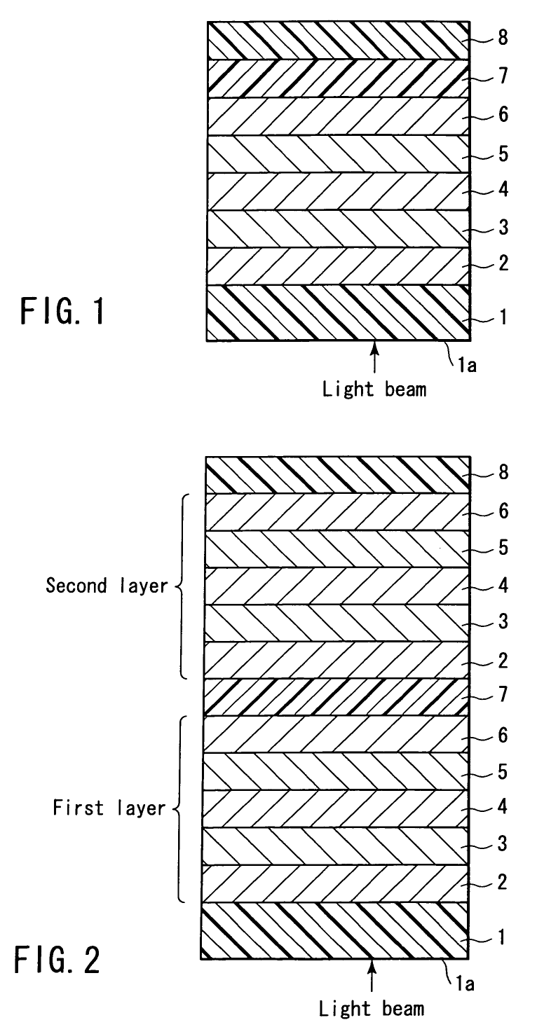

FIG. 1 is a view showing a section of a phase change optical recording medium having a single-side, single recording layer according to the first embodiment of the present invention. As shown in FIG. 1, the phase change optical recording medium sequentially comprises a light-incident-side transparent substrate 1, first dielectric layer (high thermal conductivity) 2, second dielectric layer (low thermal conductivity) 3, phase change recording layer 4, third dielectric layer 5, reflecting layer 6, UV curing layer 7, and substrate 8.

FIG. 2 is a view showing a section of a phase change optical recording medium having single-side, multiple recording layers (two layers) according to the first embodiment of the present invention. As shown in FIG. 2, the phase change optical recording medium sequentially comprises the light-incident-side transparent substrate 1, first dielectric layer (high thermal conductivity) 2, second dielectric layer (low thermal conductivity) 3, phase change recording layer 4, third dielectric layer 5, reflecting layer 6, UV curing layer 7, first dielectric layer (high thermal conductivity) 2, second dielectric layer (low thermal conductivity) 3, phase change recording layer 4, third dielectric layer 5, reflecting layer 6, and substrate 8.

A light beam becomes incident from a light incident surface 1a of the light-incident-side transparent substrate 1. Upon receiving the light beam, the phase change recording layer 4 changes from a crystalline state to an amorphous state and vice versa so that information is recorded or erased.

As the light-incident-side transparent substrate 1, a pre-formatted polycarbonate substrate is generally used. The thickness is typically 1.2 mm or 0.6 mm. Alternatively, for example, a 0.1-mm thick flat plate made of polycarbonate or a UV curing resin may be used. In the single recording layer, the light-incident-side transparent substrate 1, first dielectric layer (high thermal conductivity) 2, second dielectric layer (low thermal conductivity) 3, phase change recording layer 4, third dielectric layer 5, reflecting layer 6, UV curing layer 7, and substrate 8 are formed in this order or in a reverse order. This basically applies to the multiple recording layers.

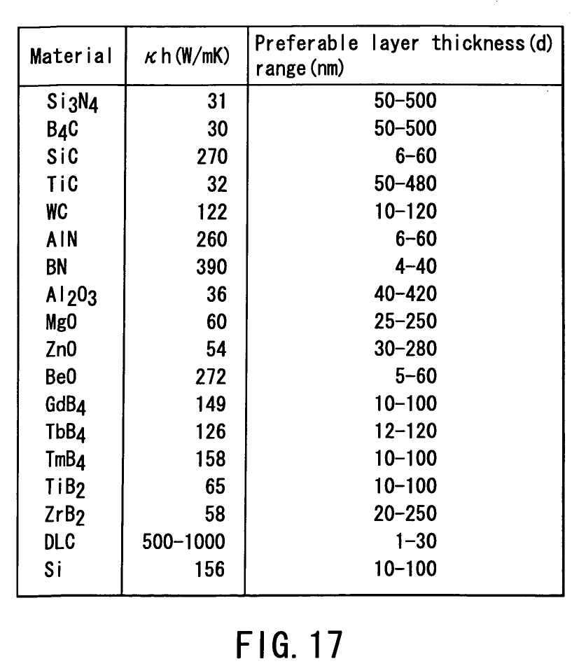

The first dielectric layer (high thermal conductivity) 2 has a thermal conductivity higher than that of the second dielectric layer (low thermal conductivity) 3. The first dielectric layer (high thermal conductivity) 2 contains, e.g., at least one material selected from materials shown in FIG. 17.

FIG. 17 is a table showing the materials of the first dielectric layer (high thermal conductivity) 2, the thermal conductivities (κh) of the bulks of the respective materials at room temperature (about 300 K), and the ranges of layer thickness (d) of the first dielectric layer (high thermal conductivity) 2. The reason why κh and d of the high-thermal-conductivity film are preferably set as shown in FIG. 17 will be described later. As shown in FIG. 17, independently of the material used for the first dielectric layer (high thermal conductivity) 2, the appropriate range of κh×d approximately satisfies

1.5×10E-6(W/K)≦κh×d≦1.5×10E-5(W/K) (1)

Of the materials shown in FIG. 17, Si is not a dielectric material. However, Si has an effect equivalent to that of the first dielectric layer (high thermal conductivity) 2 of the present invention when the layer thickness is about 20 nm or less even at a short wavelength (e.g., 405 nm used to practice the present invention) with relatively large absorption.

When the wavelength is short, and absorption is small, a thicker layer can also be used. FIG. 17 therefore shows all layer thickness ranges which are preferable for simultaneously satisfying the recording sensitivity and the XE value.

The first dielectric layer (high thermal conductivity) 2 preferably contains at least one material selected from SiC, WC, AlN, BN, BeO, GdB₄, TbB₄, TmB₄, and DLC (Diamond Like Carbon) as a material which has a high thermal conductivity K h of 100 (W/mK) or more and exhibits a sufficient XE reduction effect even when the thickness d is small.

The first dielectric layer (high thermal conductivity) 2 also preferably contains at least one material selected from AlN, BN, and DLC as a material which has a sufficiently small extinction coefficient and easily exhibits a high transmittance even when the thickness is large even in sputtering and, more particularly, cold sputtering optimum for film formation for an optical disk.

The material selection range of the first dielectric layer (high thermal conductivity) 2 does not particularly largely depend on the layer structure of the medium. The above-described material selection for the first dielectric layer (high thermal conductivity) 2 can be applied not only to the first embodiment described here but also to the remaining embodiments (to be described later).

The second dielectric layer (low thermal conductivity) 3 preferably contains at least one material selected from ZnS—SiO₂, SiO₂, ZrO₂, BaTiO₃, TiO₂, sialon, mullite, ZrSiO₄, Cu₂O, CeO₂, HfO₂, MgF₂, CaF₂, SrF₂, a plasma polymer film having a C—H bond or C—F bond, an organic sputter film having a C—F bond, and an organic spin-coat film. Most preferably, ZnS—SiO₂ that has an excellent overwrite durability is employed.

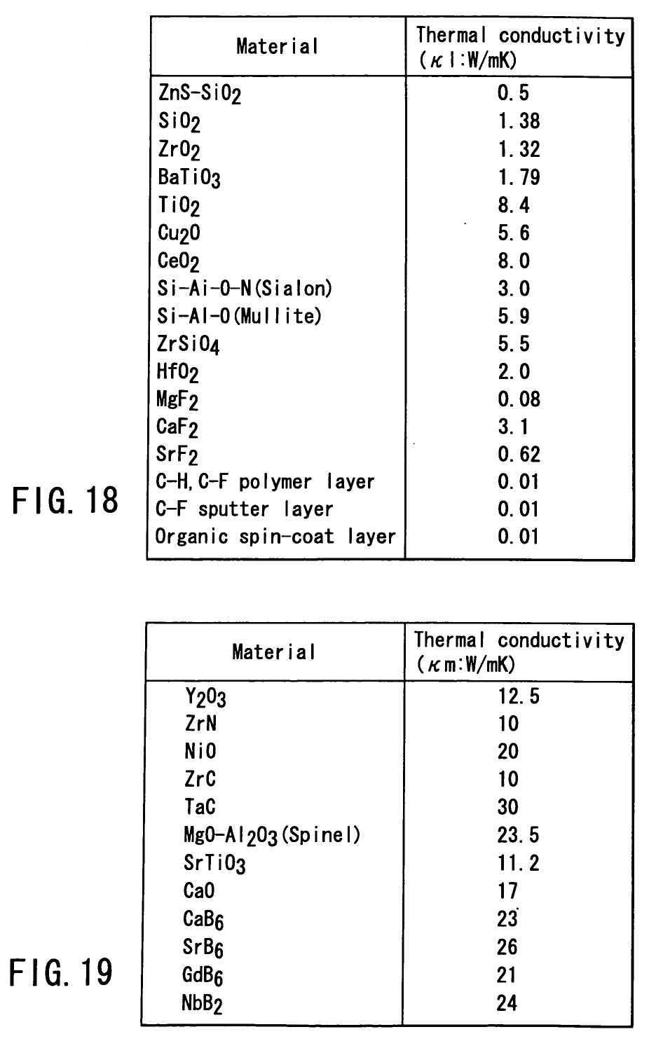

The difference in thermal conductivity between the first dielectric layer (high thermal conductivity) 2 and the second dielectric layer (low thermal conductivity) 3 will be clarified on the basis of FIGS. 18 and 19. FIG. 18 is a table showing the relationship between the thermal conductivities and materials of the second dielectric layer (low thermal conductivity) 3. FIG. 19 is a table showing the relationship between the thermal conductivities and materials of an intermediate-thermal-conductivity dielectric layer between the first dielectric layer (high thermal conductivity) 2 and the second dielectric layer (low thermal conductivity) 3. When condition (1) described above is satisfied, the material of the intermediate-thermal-conductivity dielectric layer shown in FIG. 19 may be used for the second dielectric layer (low thermal conductivity) 3.

As the phase change recording layer 4, GeSbTe or AgInSbTe is typically used. As its composition range, a known range can be used. As, e.g., GeSbTe, a material in a composition region that includes a line that connects two intermetallic compounds, GeTe and Sb₂Te₃, i.e., a so-called pseudo binary alloy composition line and, that falls within ±5% perpendicularly to the pseudo binary alloy composition line, or a so-called high-speed crystal growth composition obtained by adding about 5 to 20 at % of Ge to an SbTe alloy having an Sb₇₀Te₃₀ eutectic composition ±10 at % is typically used. As AgInSbTe, a composition obtained by adding appropriate amounts of Ag and In to the Sb₇₀Te₃₀ eutectic composition is typically used.

When an interface layer having a thickness of several nm and made of a material selected from GeN, HfO₂, CeO₂, and Ta₂O₅ is formed on the upper surface, the lower surface, or both the upper and lower surfaces of the phase change recording layer 4 as needed, the erase efficiency in a high-linear-velocity operation mode can be increased. The erase efficiency can also be increased by substituting or adding several at % of Bi or Sn to the recording layer, instead of using an interface layer. Both substitution or addition of Bi or Sn and an interface layer may be used.

The material of the third dielectric layer 5 can freely be selected from the materials shown in, e.g., FIGS. 17 to 19. The third dielectric layer 5 can be either a single layer or a double layer.

For the reflecting layer 6, an alloy film such as AlTi or AlMo that contains Al as a principal component or an alloy film such as AgPdCu or AgNdCu that contains Ag as a principal component is used. The reflecting layer 6 is typically formed as a total reflecting layer. However, the reflecting layer 6 may be a semi-transparent reflecting layer aiming at adjusting Ac and Aa. In this case, various metal particle dispersed films or Si or Ge can be used for the reflecting layer 6.

The UV curing layer 7 serves as a protective member. The substrate 8 serving as a counter substrate is bonded to the upper surface of the UV curing layer 7 via an adhesive layer.

The typical manufacturing method for the medium having the above-described structure is the same as that for a normal phase change optical disk. The transparent substrate 1 can be prepared by, e.g., master preparation by a mastering process, stamper preparation by an Ni electroforming process, and transparent substrate preparation by an injection molding process. Thin films such as the first dielectric layer (high thermal conductivity) 2, second dielectric layer (low thermal conductivity) 3, phase change recording layer 4, third dielectric layer 5, and reflecting layer 6 are typically formed by a sputtering process. Vapor deposition, plasma polymerization, or spin coating may also be used. The thermal conductivity of a thin film changes depending on the film forming apparatus and film forming conditions (for, e.g., sputtering, the gas species, gas pressure, the input power to a target, and the like) but normally exhibits a value equal to or smaller by 20% to 30% than that of the bulk material. When condition (1) is satisfied, the thermal conductivity of a bulk described in, e.g., a thermophysical property handbook is used. After the thin films are formed by sputtering, the above-described protective member or counter substrate is bonded. The phase change recording layer is subjected to initial crystallization using a general bulk initializer. Then, the medium is used for a recording/reproduction operation.

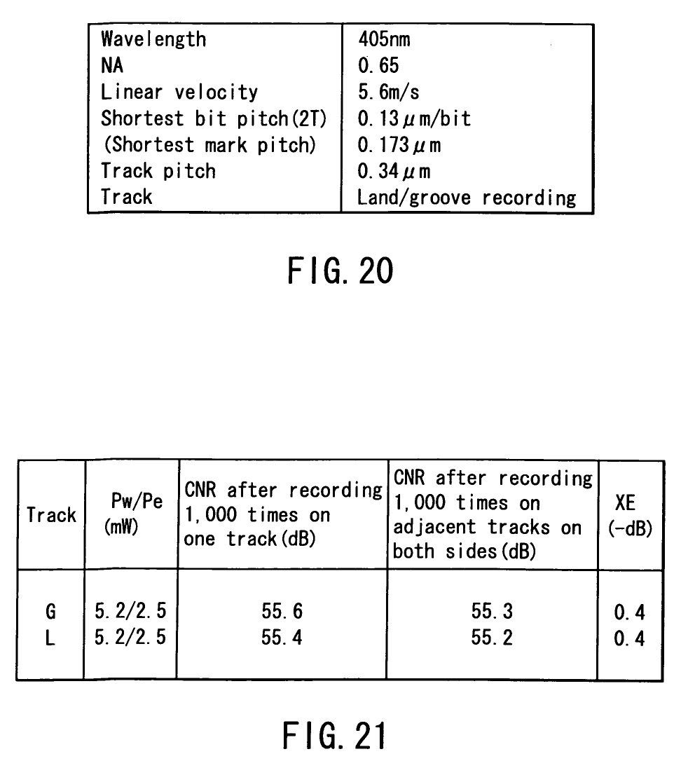

FIG. 20 is a table showing the evaluation conditions of the recording/reproduction characteristic of the phase change optical recording medium. Assume, e.g., a semiconductor laser source having a wavelength of 405 nm and an objective lens having an NA of 0.65. However, the present invention is related to a phase change optical recording medium, and therefore, the operating wavelength and NA are not particularly limited. When the wavelength changes, the product of the extinction coefficient and the thickness becomes small at that wavelength. In addition, dielectric materials that should be selected to satisfy a single layer transmittance of about 80% or more and, more preferably, 90% or more change. Furthermore, the optical design value of the thickness of each layer changes. The linear velocity is assumed to mainly be 5.6 m/s. However, the present invention is effective in any practical linear velocity range of several m/s to several ten m/s, as described above.

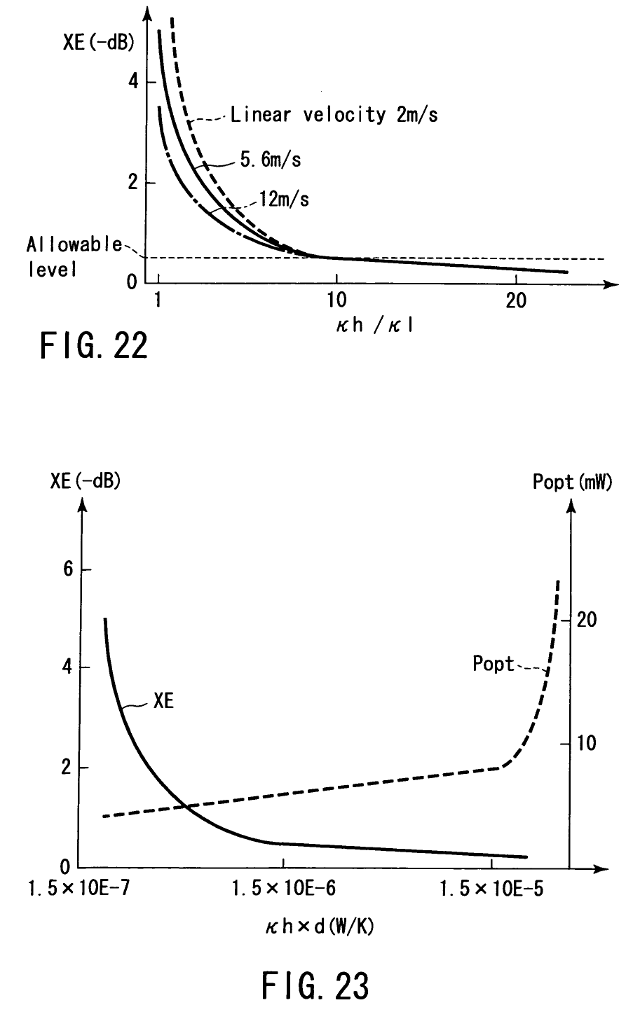

FIG. 22 is a graph showing an example of a recording/reproduction test result. The abscissa represents the ratio of the thermal conductivity κ of the first dielectric layer (high thermal conductivity) 2 and that of the second dielectric layer (low thermal conductivity) 3. The ordinate represents the cross erase (XE) value at a track pitch of 0.34 μm. The XE values were measured in the following way. First, random data was recorded on a groove (G) track 10 times by overwrite recording. Then, a signal having a single frequency of 9T (corresponding to a mark pitch of 0.78 μm) was recorded, and the carrier level was measured. Next, random data was recorded on adjacent land (L) tracks on both sides 10 times by overwrite recording. The carrier level of the G track in the middle was measured. The carrier level difference of the G track before and after recording on the L tracks was checked. The XE value allowable in the system is smaller than 0.5 dB.

FIG. 22 shows a result of experiments conducted while changing the dielectric materials of the first dielectric layer (high thermal conductivity) 2 and second dielectric layer (low thermal conductivity) 3. Every time the dielectric materials were changed, a medium film was formed by designing the thicknesses of the respective layers in accordance with the optical constants of the dielectric materials such that the optical contrast ratio (|Rc−Ra|)/(Rc+Ra) was maximized. As the thickness of the first dielectric layer (high thermal conductivity) 2, a value with which a high contrast ratio could be obtained was selected from the preferable ranges shown in FIG. 17. In recording/reproduction evaluation, the effect was clarified by changing the linear velocity from 5.6 m/s to several values. As is apparent from FIG. 22, when the ratio of the thermal conductivity K h of the first dielectric layer (high thermal conductivity) 2 to the thermal conductivity κ1 of the second dielectric layer (low thermal conductivity) 3 is set to 10 or more, XE exhibits a practical value of 0.5 dB or less. Referring to FIG. 22, a case wherein the ratio of the thermal conductivity κh of the first dielectric layer (high thermal conductivity) 2 to the thermal conductivity κ1 of the second dielectric layer (low thermal conductivity) 3 is 1 corresponds to a case wherein the first dielectric layer (high thermal conductivity) 2 does not exist in FIG. 1. The conditions shown in FIG. 20 were used. More specifically, land/groove (L/G) recording was used while setting the spot size of the recording/reproduction laser on the medium surface to about 0.32 μm as a full width at half maximum (FWHM) or about 0.52 μm as an e-2 diameter, and the track pitch to 0.34 μm. In the same medium, the XE value is large when the track pitch is small, or small when the track pitch is large, as a matter of course. In the medium of the present invention, the XE value can be made small to increase the track density (decrease the track pitch). That is, a track pitch close to the FWHM was selected. The track pitch range where the present invention has an effect is from the FWHM of the spot to 75% of the e-2 diameter. In this range, κh×d is preferably set to be relatively large as the track pitch becomes small. When the track pitch is large, the selection range of κh×d is extended to the smaller side.

FIG. 23 is a graph showing a result obtained by checking the XE value and the recording sensitivity while changing the material and thickness of the first dielectric layer (high thermal conductivity) 2 and κh×d. For the second dielectric layer (low thermal conductivity) 3, ZnS—SiO₂ having a thermal conductivity of about 0.5 (W/km) was used. The recording sensitivity was defined as a recording power (Popt) at which CNR was saturated when a signal having a single frequency of 9T was recorded and at which the second-order harmonic was minimized. As is apparent, when κh×d is smaller than the lower limit defined in condition (1), XE abruptly degrades. When κh×d is larger than the upper limit defined in condition (1), the recording sensitivity abruptly degrades. When κh×d is too small, the XE value becomes large because the thermal conduction promoting effect in the film thickness direction is poor. When κh×d is too large, Popt becomes too high because the thermal conduction promoting effect is too large, and the temperature of the recording layer hardly reaches the melting point or more. Popt also depends on the linear velocity. Under the evaluation conditions shown in FIG. 20, when the format efficiency is about 82%, a user data transfer rate of 35 Mbps is obtained. This is a typical value for, e.g., a next-generation DVD compatible with a high-definition moving image. If the linear velocity is reduced, any excess increase in Popt can be avoided even when κh×d exceeds the upper limit of the present invention. However, an embodiment with a low transfer rate is not advantageous for practical use. In the present invention, therefore, a value at which a practical sensitivity can be obtained at a practical transfer rate is defined as the upper limit value of κh×d.

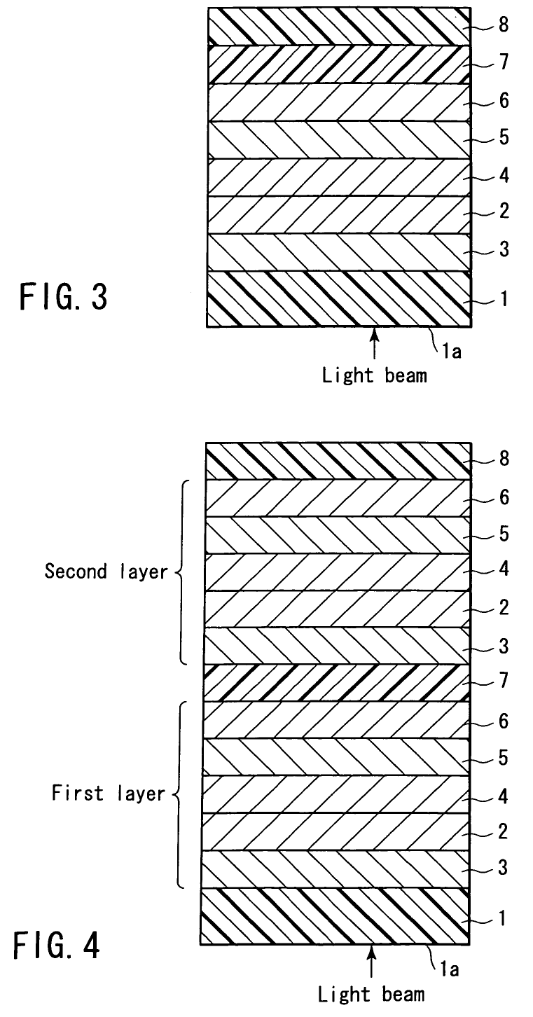

FIG. 3 is a view showing a section of a phase change optical recording medium having a single-side, single recording layer according to the second embodiment of the present invention. As shown in FIG. 3, the phase change optical recording medium sequentially comprises a light-incident-side transparent substrate 1, second dielectric layer (low thermal conductivity) 3, first dielectric layer (high thermal conductivity) 2, phase change recording layer 4, third dielectric layer 5, reflecting layer 6, UV curing layer 7, and substrate 8. That is, in the phase change optical recording medium having a single-side, single recording layer according to the first embodiment shown in FIG. 1, the positions of the first dielectric layer (high thermal conductivity) 2 and second dielectric layer (low thermal conductivity) 3 are replaced.

FIG. 4 is a view showing a section of a phase change optical recording medium having single-side, multiple recording layers (two layers) according to the second embodiment of the present invention. As shown in FIG. 4, the phase change optical recording medium sequentially comprises the light-incident-side transparent substrate 1, second dielectric layer (low thermal conductivity) 3, first dielectric layer (high thermal conductivity) 2, phase change recording layer 4, third dielectric layer 5, reflecting layer 6, UV curing layer 7, second dielectric layer (low thermal conductivity) 3, first dielectric layer (high thermal conductivity) 2, phase change recording layer 4, third dielectric layer 5, reflecting layer 6, and substrate 8.

Reference numerals applied to the layers of the phase change optical recording medium according to the second embodiment are associated with those applied to the phase change optical recording medium according to the first embodiment. That is, the same reference numerals denote the same parts.

As shown in FIGS. 1 and 2, the phase change optical recording medium of the first embodiment sequentially comprises the light-incident-side transparent substrate 1, first dielectric layer (high thermal conductivity) 2, second dielectric layer (low thermal conductivity) 3, and phase change recording layer 4. For this reason, heat is readily transmitted to the first dielectric layer (high thermal conductivity) 2. The light-incident-side transparent substrate 1 may deform or deteriorate by the influence of the heat. To the contrary, according to the layer structure of the phase change optical recording medium of the second embodiment, the second dielectric layer (low thermal conductivity) 3 is inserted between the light-incident-side transparent substrate 1 and the first dielectric layer (high thermal conductivity) 2. This solves the above-described problem.

In the phase change optical recording medium of the second embodiment, the appropriate range of κh×d is shifted to the smaller side of the range defined by condition (1). The shift amount is 20% or less. All the materials of the first dielectric layer (high thermal conductivity) 2, which are shown in FIG. 17, have hardnesses higher than that of ZnS—SiO₂. For this reason, the function of absorbing a change in volume of the phase change recording layer due to repetitive overwrite is poorer in the first dielectric layer (high thermal conductivity) 2 than in ZnS—SiO₂. However, in the form wherein the first dielectric layer (high thermal conductivity) 2 and second dielectric layer (low thermal conductivity) 3 are divisionally formed, the degree of freedom can be increased relatively. For example, a low-thermal-conductivity dielectric layer is formed first on the light-incident-side transparent substrate 1. Subsequently, a high-thermal-conductivity dielectric layer is formed. Another low-thermal-conductivity dielectric layer is formed. Then, another high-thermal-conductivity dielectric layer having a thickness of several nm is formed on the low-thermal-conductivity dielectric layer. After that, the phase change recording layer 4 is formed. In this case, satisfactory characteristics including the overwrite durability can be obtained. When the high-thermal-conductivity dielectric film is divisionally formed, the total thickness only needs to satisfy condition (1).

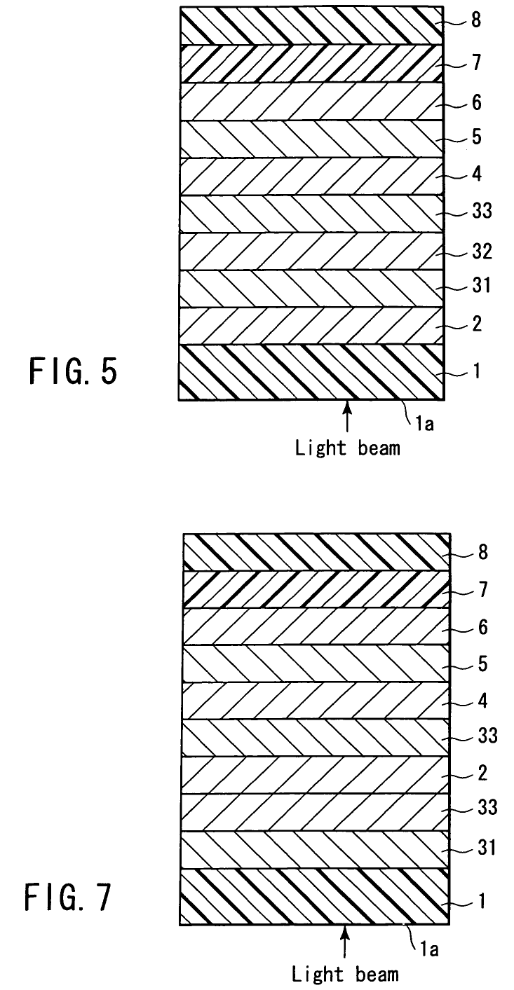

FIG. 5 is a view showing a section of a phase change optical recording medium having a single-side, single recording layer according to the third embodiment of the present invention. As shown in FIG. 5, the phase change optical recording medium sequentially comprises a light-incident-side transparent substrate 1, first dielectric layer (high thermal conductivity) 2, dielectric layer 31 with a first reflective index, dielectric layer 32 with a second reflective index, dielectric layer 33 with a third reflective index, phase change recording layer 4, third dielectric layer 5, reflecting layer 6, UV curing layer 7, and substrate 8.

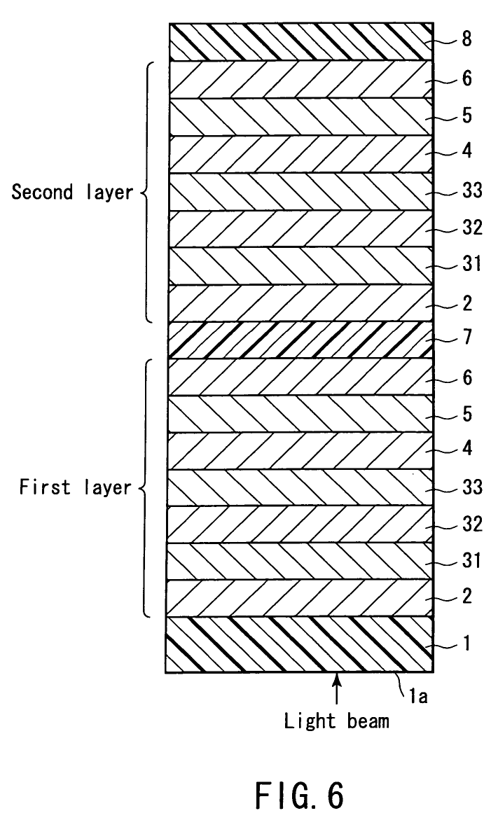

FIG. 6 is a view showing a section of a phase change optical recording medium having single-side, multiple recording layers (two layers) according to the third embodiment of the present invention. As shown in FIG. 6, the phase change optical recording medium sequentially comprises the light-incident-side transparent substrate 1, first dielectric layer (high thermal conductivity) 2, dielectric layer 31 with the first reflective index, dielectric layer 32 with the second reflective index, dielectric layer 33 with the third reflective index, phase change recording layer 4, third dielectric layer 5, reflecting layer 6, UV curing layer 7, first dielectric layer (high thermal conductivity) 2, dielectric layer 31 with the first reflective index, dielectric layer 32 with the second reflective index, dielectric layer 33 with the third reflective index, phase change recording layer 4, third dielectric layer 5, reflecting layer 6, and substrate 8.

Reference numerals applied to the layers of the phase change optical recording medium according to the third embodiment are associated with those applied to the phase change optical recording medium according to the first embodiment. That is, the same reference numerals denote the same parts.

The first refractive index is different from the second refractive index. The second refractive index is different from the third refractive index. At least one of the dielectric layer 31 with the first reflective index, dielectric layer 32 with the second reflective index, and dielectric layer 33 with the third reflective index corresponds to a second dielectric layer (low thermal conductivity) 3. For a high-refractive-index layer, ZnS—SiO₂, TiO₂, Si₃N₄, Nb₂O₅, ZrO₂, or ZnO can be used. For a low-refractive-index layer, SiO₂, MgF₂, CaF₂, a plasma polymer film, or an organic spin-coat film can be used. In addition, a film having a refractive index higher than that of a low-refractive-index layer and, for example, a film made of a B₄C, SiC, WC, AlN, BN, DLC, or various borides selected from the materials shown in FIG. 17 may be used as a high-refractive-index layer.

In the third embodiment, a medium having one first dielectric layer (high thermal conductivity) 2 and three dielectric layers 31, 32, and 33 has been described. However, the present invention is not limited to this. A plurality of first dielectric layers (high thermal conductivity) 2 may be formed. For example, a plurality of first dielectric layers (high thermal conductivity) 2 may be formed, and at least one of the dielectric layers 31, 32, and 33 may be inserted between the first dielectric layers (high thermal conductivity) 2.

The first dielectric layer (high thermal conductivity) 2 and substrate 1 need not always be in contact. For example, at least one of the dielectric layers 31, 32, and 33 may be inserted between the first dielectric layer (high thermal conductivity) 2 and the substrate 1. More specifically, the substrate 1, at least one of the dielectric layers 31, 32, and 33, the first dielectric layer (high thermal conductivity) 2, and at least one of the dielectric layers 31, 32, and 33 may be formed in this order. The first dielectric layer (high thermal conductivity) 2 and phase change recording layer 4 may come into direct contact with each other.

As a point of the third embodiment, the second dielectric layer (low thermal conductivity) 3 is applied to at least one of the three dielectric layers 31, 32, and 33. The relationship between a thermal conductivity κ1 of the second dielectric layer (low thermal conductivity) 3 and a thermal conductivity κh of the first dielectric layer (high thermal conductivity) 2 satisfies κh/κ1≧10 and condition (1). In a range where the two conditions are satisfied, the degree of freedom in selecting the film structure and film materials is high. As for, e.g., the film materials, at least one of the three dielectric layers 31, 32, and 33 is made as the second dielectric layer (low thermal conductivity) 3. The two remaining dielectric layers can freely be selected from the high-thermal-conductivity materials shown in FIG. 17, low-thermal-conductivity materials shown in FIG. 18, and intermediate-thermal-conductivity materials shown in FIG. 19.

The effects of the third embodiment can be confirmed to be almost the same as those obtained in the first embodiment (the effects shown in FIGS. 22 and 23) by checking them in accordance with the same procedures as in the first embodiment. As the position of the first dielectric layer (high thermal conductivity) 2 becomes closer to the recording layer, Popt becomes high, and XE becomes small, as in the first embodiment. The shift amount of the appropriate range of κh×d is about 20% or less, as in the first embodiment.

FIG. 7 is a view showing a section of a phase change optical recording medium having a single-side, single recording layer according to the fourth embodiment of the present invention. As shown in FIG. 7, the phase change optical recording medium sequentially comprises a light-incident-side transparent substrate 1, dielectric layer (high refractive index) 31 with a first reflective index, dielectric layer (low refractive index) 32 with a second reflective index, first dielectric layer (high thermal conductivity) 2, dielectric layer (high refractive index) 33 with a third reflective index, phase change recording layer 4, third dielectric layer 5, reflecting layer 6, UV curing layer 7, and substrate 8.

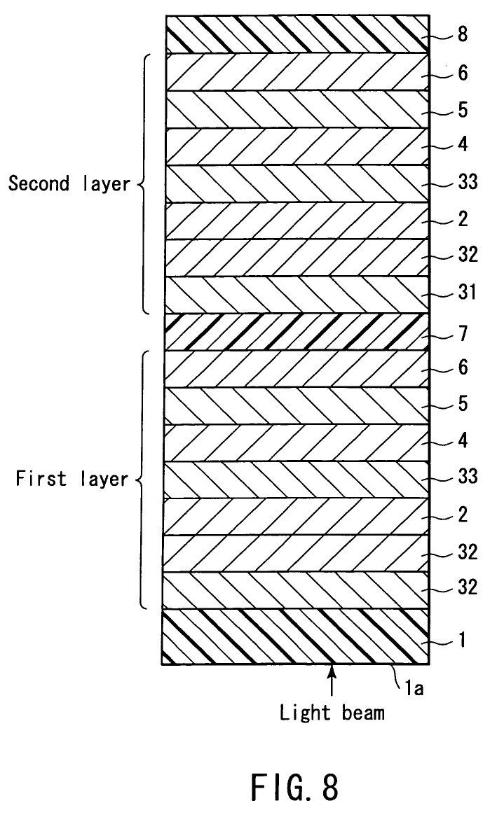

FIG. 8 is a view showing a section of a phase change optical recording medium having single-side, multiple recording layers (two layers) according to the fourth embodiment of the present invention. As shown in FIG. 8, the phase change optical recording medium sequentially comprises the light-incident-side transparent substrate 1, dielectric layer (high refractive index) 31 with the first reflective index, dielectric layer (low refractive index) 32 with the second reflective index, first dielectric layer (high thermal conductivity) 2, dielectric layer (high refractive index) 33 with the third reflective index, phase change recording layer 4, third dielectric layer 5, reflecting layer 6, UV curing layer 7, dielectric layer (high refractive index) 31 with the first reflective index, dielectric layer (low refractive index) 32 with the second reflective index, first dielectric layer (high thermal conductivity) 2, dielectric layer (high refractive index) 33 with the third reflective index, phase change recording layer 4, third dielectric layer 5, reflecting layer 6, and substrate 8.

Reference numerals applied to the layers of the phase change optical recording medium according to the fourth embodiment are associated with those applied to the phase change optical recording medium according to the third embodiment. That is, the same reference numerals denote the same parts.

The first refractive index is higher than the second refractive index. The second refractive index is different from the third refractive index. In the fourth embodiment, three dielectric layers are formed between the phase change recording layer 4 and the substrate 1. However, the number of dielectric layers is not limited to three as long as a plurality of dielectric layers exist.

As for material selection for each dielectric film, for a high-refractive-index layer, ZnS—SiO₂, TiO₂, Si₃N₄, Nb₂O₅, ZrO₂, or ZnO can be used. For a low-refractive-index layer, SiO₂, MgF₂, CaF₂, a plasma polymer film, or an organic spin-coat film can be used. In addition, a film having a refractive index higher than that of a low-refractive-index layer and, for example, a film made of a B₄C, SiC, WC, AlN, BN, DLC, or various borides selected from the materials shown in FIG. 17 may be used as a high-refractive-index layer.

A detailed example of the fourth embodiment will be described here. A pre-formatted polycarbonate L/G substrate having a thickness of 0.6 mm is selected as the transparent substrate 1. A dielectric layer (high refractive index) 31 with the first reflective index, dielectric layer (low refractive index) 32 with the second reflective index, first dielectric layer (high thermal conductivity) 2, dielectric layer (high refractive index) 33 with the third reflective index, phase change recording layer 4, third dielectric layer 5, and reflecting layer 6 are sequentially formed on the transparent substrate 1 by sputtering. The dielectric layer 31 is made of a ZnS—SiO₂ layer having a thickness of 10 to 30 nm. The dielectric layer 32 is made of an SiO₂ layer having a thickness of 30 to 60 nm. The first dielectric layer 2 is made of an AlN layer having a thickness of 10 to 30 nm. The dielectric layer 33 is made of a ZnS—SiO layer having a thickness of 10 to 30 nm. The phase change recording layer 4 is made of a Ge₄₀Sb₄Bi₄Te₅₂ layer having a thickness of 10 to 20 nm. The third dielectric layer 5 is made of a ZnS—SiO₂ layer having a thickness of 10 to 40 nm. The reflecting layer 6 is made of an AgPdCu layer having a thickness of 50 to 200 nm. After that, the counter substrate 8 made of polycarbonate and having a thickness of 0.6 mm is bonded via the UV curing layer 7 and an adhesive layer. The phase change recording layer 4 was subjected to initial crystallization using a bulk initializer. Then, a recording/reproduction test was executed. This layer structure satisfies Rc<Ra and Ac>Aa. Rc exhibited a practical value of 5% or more. The recording/reproduction test was executed using the conditions shown in FIG. 20. After single track random overwrite was executed 1,000 times, a signal having a single frequency for a 9T mark pitch was recorded, and the 9T-CNR was measured. Next, random patterns were overwritten on adjacent tracks on both sides 1,000 times. The 9T-CNR of the track in the middle was measured. XE was measured by using the same method as in the first embodiment. FIG. 21 shows the evaluation result of this detailed example. CNR after the 1,000-times single track random overwrite indicates a very large value. CNR after random patterns were overwritten 1,000 times on adjacent tracks on both sides also maintains the same value as that before recording on the adjacent tracks. This proves that the influence of XE is substantially eliminated. XE that was checked by the same evaluation method as in first embodiment is also smaller than 0.5 dB. It meets the system requirement. The bER of the medium that exhibited such excellent analog characteristics was checked by applying a PRML modulation scheme. As a result, the bottom bER was 2.7×10E-5 for G and 8.7×10E-6 for L. That is, the values are much smaller than 10E-4 of the system requirement, and the effect of the present invention is proved. Referring to FIG. 21, Pw/Pe represents amorphous forming power (recording power)/crystallization power (erase power). Pw is almost the same as Popt.

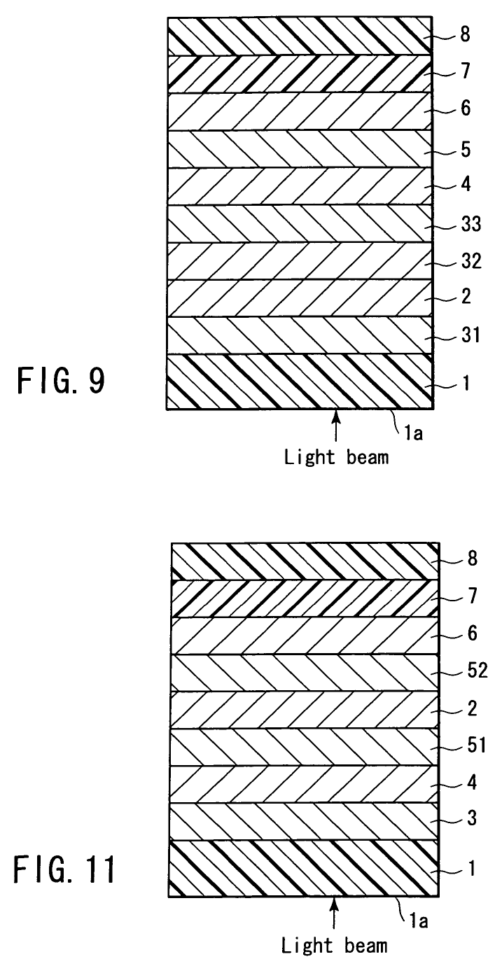

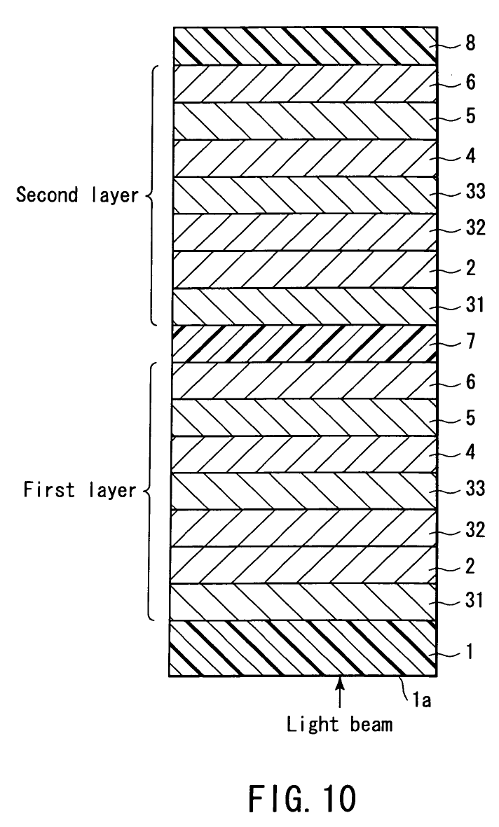

The fifth embodiment as a modification to the fourth embodiment will be described next with reference to FIGS. 9 and 10.

FIG. 9 is a view showing a section of a phase change optical recording medium having a single-side, single recording layer according to the fifth embodiment of the present invention. As shown in FIG. 9, the phase change optical recording medium sequentially comprises a light-incident-side transparent substrate 1, dielectric layer (high refractive index) 31 with a first reflective index, first dielectric layer (high thermal conductivity) 2, dielectric layer (low refractive index) 32 with a second reflective index, dielectric layer (high refractive index) 33 with a third reflective index, phase change recording layer 4, third dielectric layer 5, reflecting layer 6, UV curing layer 7, and substrate 8.

FIG. 10 is a view showing a section of a phase change optical recording medium having single-side, multiple recording layers (two layers) according to the fifth embodiment of the present invention. As shown in FIG. 10, the phase change optical recording medium sequentially comprises the light-incident-side transparent substrate 1, dielectric layer (high refractive index) 31 with the first reflective index, first dielectric layer (high thermal conductivity) 2, dielectric layer (low refractive index) 32 with the second reflective index, dielectric layer (high refractive index) 33 with the third reflective index, phase change recording layer 4, third dielectric layer 5, reflecting layer 6, UV curing layer 7, dielectric layer (high refractive index) 31 with the first reflective index, first dielectric layer (high thermal conductivity) 2, dielectric layer (low refractive index) 32 with the second reflective index, dielectric layer (high refractive index) 33 with the third reflective index, phase change recording layer 4, third dielectric layer 5, reflecting layer 6, and substrate 8.

Reference numerals applied to the layers of the phase change optical recording medium according to the fifth embodiment are associated with those applied to the phase change optical recording medium according to the fourth embodiment. That is, the same reference numerals denote the same parts. The fifth embodiment is a modification to the fourth embodiment. The details are the same as in the fourth embodiment. The same effects as in the fourth embodiment can be obtained.

FIG. 11 is a view showing a section of a phase change optical recording medium having a single-side, single recording layer according to the sixth embodiment of the present invention. As shown in FIG. 11, the phase change optical recording medium sequentially comprises a light-incident-side transparent substrate 1, second dielectric layer (low thermal conductivity) 3, phase change recording layer 4, third dielectric layer 51, first dielectric layer (high thermal conductivity) 2, fourth dielectric layer 52, reflecting layer 6, UV curing layer 7, and substrate 8.

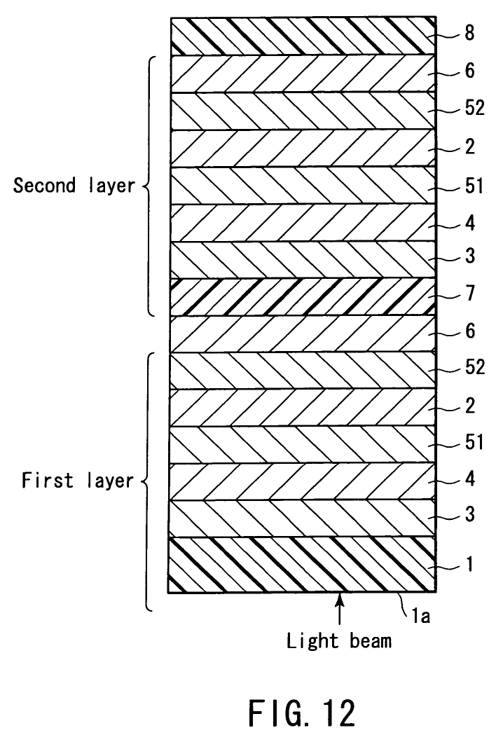

FIG. 12 is a view showing a section of a phase change optical recording medium having single-side, multiple recording layers (two layers) according to the sixth embodiment of the present invention. As shown in FIG. 12, the phase change optical recording medium sequentially comprises the light-incident-side transparent substrate 1, second dielectric layer (low thermal conductivity) 3, phase change recording layer 4, third dielectric layer 51, first dielectric layer (high thermal conductivity) 2, fourth dielectric layer 52, reflecting layer 6, UV curing layer 7, second dielectric layer (low thermal conductivity) 3, phase change recording layer 4, third dielectric layer 51, first dielectric layer (high thermal conductivity) 2, fourth dielectric layer 52, reflecting layer 6, and substrate 8.

Reference numerals applied to the layers of the phase change optical recording medium according to the sixth embodiment are associated with those applied to the phase change optical recording medium according to the first embodiment. That is, the same reference numerals denote the same parts.

As a characteristic feature of the sixth embodiment, the first dielectric layer (high thermal conductivity) 2 is formed on a surface opposite to the light-incident-side surface of the phase change recording layer 4. With this structure, both Popt and XE can be simultaneously satisfied, as in the remaining embodiments. In addition, at least one of the third dielectric layer 51 and fourth dielectric layer 52 is made of a low-thermal-conductivity dielectric material. The relationship between a thermal conductivity κ1 of the low-thermal-conductivity dielectric material and a thermal conductivity κh of the first dielectric layer (high thermal conductivity) 2 satisfies κh/κ1≧10 and condition (1). In a range where the two conditions are satisfied, the degree of freedom in selecting the film structure and film materials is high. For example, each of the third dielectric layer 51, first dielectric layer (high thermal conductivity) 2, and fourth dielectric layer 52 may have a single-layer structure, as shown in FIGS. 11 and 12 or a multilayered structure (not shown).

The position of the first dielectric layer (high thermal conductivity) 2 is not limited to the position between the third dielectric layer 51 and the fourth dielectric layer 52. For example, the first dielectric layer (high thermal conductivity) 2 may be formed immediately on the phase change recording layer 4 or to be adjacent to the reflecting layer 6. For the medium according to the sixth embodiment as well, samples were prepared by using various dielectric materials, and a recording/reproduction test was executed. As a result, almost the same effects as in the first embodiment (FIGS. 22 and 23) were obtained. The medium according to the sixth embodiment basically exhibits an optical response represented by Rc>Ra and Ac<Aa. However, it may be designed by applying, e.g., conditions (1) to (3) below such that an optical response represented by Rc>Ra and Ac>Aa is obtained.

(1) A semi-transparent film is inserted immediately on the transparent substrate 1.

(2) A semi-transparent material is used for the reflecting layer 6.

(3) In addition to the third dielectric layer 51, first dielectric layer (high thermal conductivity) 2, and fourth dielectric layer 52, a semi-absorbing film material is inserted between the phase change recording layer 4 and the reflecting layer 6.

A detailed example will be described. A semi-transparent layer, a second dielectric layer (low thermal conductivity) 3, an interface layer, a phase change recording layer 4, another interface layer, the third dielectric layer 51, a first dielectric layer (high thermal conductivity) 2, a fourth dielectric layer 52, and a reflecting layer 6 are sequentially formed on the transparent substrate 1. The semi-transparent layer is made of an AgPdCu layer having a thickness of 5 to 20 nm. The second dielectric layer 3 is made of a ZnS—SiO₂ layer having a thickness of 40 to 80 nm. The interface layer is made of an HfO₂ layer having a thickness of 1 to 5 nm. The phase change recording layer 4 is made of a Ge₄₀Sb₈Te₅₂ layer having a thickness of 10 to 20 nm. Another interface layer is made of an HfO₂ layer having a thickness of 1 to 5 nm. The third dielectric layer 51 is made of a ZnS—SiO₂ layer having a thickness of 5 to 25 nm. The first dielectric layer 2 is made of a BN layer having a thickness of 5 to 30 nm. The fourth dielectric layer 52 is made of a ZnS—SiO₂ layer having a thickness of 5 to 25 nm. The reflecting layer 6 is made of an AgNdCu layer having a thickness of 50 to 200 nm. This medium is designed to satisfy Rc>Ra and Ac>Aa. That is, Rc is about 20%, i.e., has a sufficiently large value for a header signal or servo signal. The same recording/reproduction characteristic as that shown in FIG. 21 was obtained.

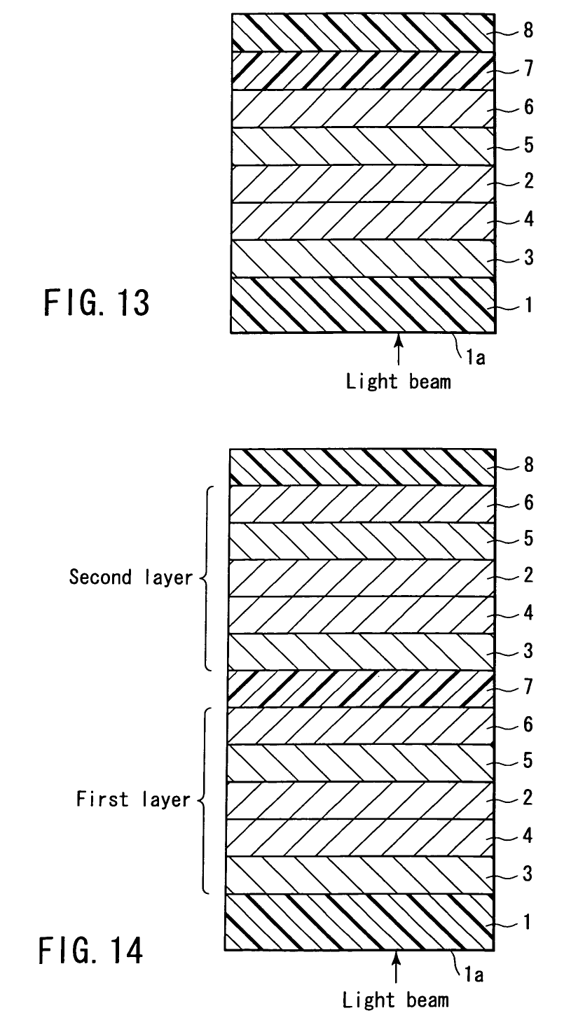

The seventh embodiment as a modification to the first and sixth embodiments will be described next with reference to FIGS. 13 and 14.

FIG. 13 is a view showing a section of a phase change optical recording medium having a single-side, single recording layer according to the seventh embodiment of the present invention. As shown in FIG. 13, the phase change optical recording medium sequentially comprises a light-incident-side transparent substrate 1, second dielectric layer (low thermal conductivity) 3, phase change recording layer 4, first dielectric layer (high thermal conductivity) 2, third dielectric layer 5, reflecting layer 6, UV curing layer 7, and substrate 8.

FIG. 14 is a view showing a section of a phase change optical recording medium having single-side, multiple recording layers (two layers) according to the seventh embodiment of the present invention. As shown in FIG. 14, the phase change optical recording medium sequentially comprises the light-incident-side transparent substrate 1, second dielectric layer (low thermal conductivity) 3, phase change recording layer 4, first dielectric layer (high thermal conductivity) 2, third dielectric layer 5, reflecting layer 6, UV curing layer 7, second dielectric layer (low thermal conductivity) 3, phase change recording layer 4, first dielectric layer (high thermal conductivity) 2, third dielectric layer 5, reflecting layer 6, and substrate 8.

Reference numerals applied to the layers of the phase change optical recording medium according to the seventh embodiment are associated with those applied to the phase change optical recording medium according to the first embodiment. That is, the same reference numerals denote the same parts. The seventh embodiment is a modification to the first and fourth embodiments. The details are the same as in the first and fourth embodiments. The same effects as in the first and fourth embodiments can be obtained.

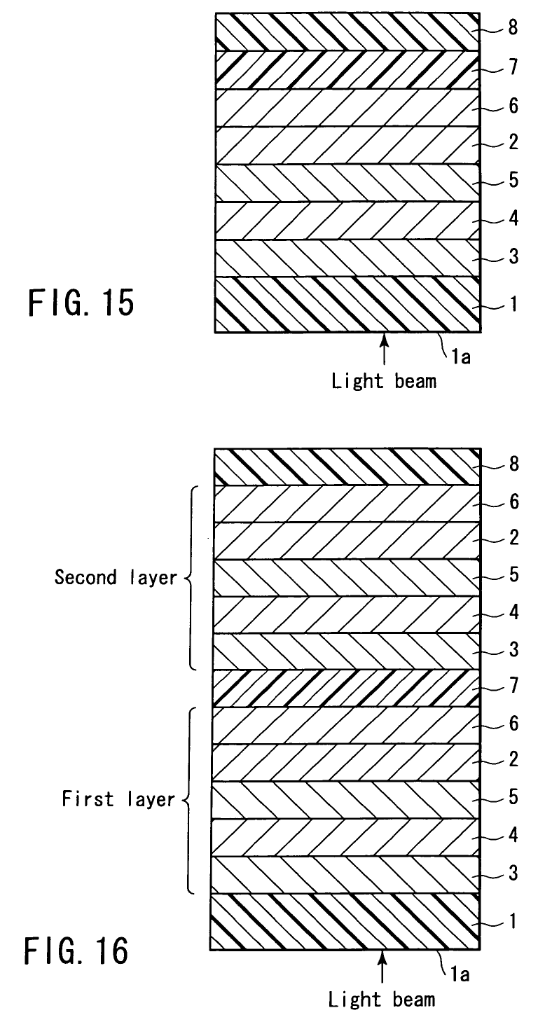

The eighth embodiment as a modification to the first and sixth embodiments will be described next with reference to FIGS. 15 and 16.

FIG. 15 is a view showing a section of a phase change optical recording medium having a single-side, single recording layer according to the eighth embodiment of the present invention. As shown in FIG. 15, the phase change optical recording medium sequentially comprises a light-incident-side transparent substrate 1, second dielectric layer (low thermal conductivity) 3, phase change recording layer 4, third dielectric layer 5, first dielectric layer (high thermal conductivity) 2, reflecting layer 6, UV curing layer 7, and substrate 8.

FIG. 16 is a view showing a section of a phase change optical recording medium having single-side, multiple recording layers (two layers) according to the eighth embodiment of the present invention. As shown in FIG. 16, the phase change optical recording medium sequentially comprises the light-incident-side transparent substrate 1, second dielectric layer (low thermal conductivity) 3, phase change recording layer 4, third dielectric layer 5, first dielectric layer (high thermal conductivity) 2, reflecting layer 6, UV curing layer 7, second dielectric layer (low thermal conductivity) 3, phase change recording layer 4, third dielectric layer 5, first dielectric layer (high thermal conductivity) 2, reflecting layer 6, and substrate 8.

Reference numerals applied to the layers of the phase change optical recording medium according to the eighth embodiment are associated with those applied to the phase change optical recording medium according to the first embodiment. That is, the same reference numerals denote the same parts. The eighth embodiment is a modification to the first and fourth embodiments. The details are the same as in the first and fourth embodiments. The same effects as in the first and fourth embodiments can be obtained.

The ninth embodiment will be described next. A phase change optical recording medium according to the ninth embodiment has a structure that combines the sixth embodiment with one of the first, third, and fourth embodiments. In this structure, a first dielectric layer (high thermal conductivity) 2 is formed under a phase change recording layer 4. When two conditions (1) and (2) below are satisfied, the degree of freedom in the layer structure is very high.

(1) The product of a total thickness d on the upper and lower sides and a thermal conductivity K h of the first dielectric layer (high thermal conductivity) 2 satisfies condition (1).

(2) At least one of dielectric layers, except the first dielectric layer (high thermal conductivity) 2, on the upper or lower side or on both sides of the phase change recording layer 4 is a second dielectric layer (low thermal conductivity) 3, and thermal conductivities κ1 and κh satisfy κh/κ1≧10.

A detailed example will be described here. A pre-formatted polycarbonate L/G substrate having a thickness of 0.6 mm is selected as the transparent substrate 1. A dielectric layer 31 with a first reflective index (high refractive index), dielectric layer 32 with a second reflective index (low refractive index), an incident-side first dielectric layer (high thermal conductivity) 2, a dielectric layer 33 with a third reflective index (high refractive index), a phase change recording layer 4, a dielectric layer 5, a reflecting-layer-side first dielectric layer (high thermal conductivity) 2, a dielectric layer, and a reflecting layer 6 are sequentially formed on the transparent substrate 1 by sputtering. The dielectric layer 31 is made of a ZnS—SiO₂ layer having a thickness of 10 to 30 nm. The dielectric layer 32 is made of an SiO₂ layer having a thickness of 30 to 60 nm. The incident-side first dielectric layer 2 is made of an AlN layer having a thickness of 5 to 15 nm. The dielectric layer 33 is made of a ZnS—SiO layer having a thickness of 10 to 30 nm. The phase change recording layer 4 is made of a Ge₄₀Sb₄Bi₄Te₅₂ layer having a thickness of 10 to 20 nm. The dielectric layer 5 is made of a ZnS—SiO₂ layer having a thickness of 5 to 20 nm. The reflecting-layer-side first dielectric layer 2 is made of a BN layer having a thickness of 5 to 20 nm. The dielectric layer is made of a ZnS—SiO₂ layer having a thickness of 5 to 20 nm. The reflecting layer 6 is made of an AgPdCu layer having a thickness of 50 to 200 nm. After that, a UV curing layer 7 is bonded via an adhesive layer, and a counter substrate 8 made of polycarbonate and having a thickness of 0.6 mm is bonded on the UV curing layer 7, thereby completing a phase change optical recording medium. For the resultant phase change optical recording medium, the phase change recording layer 4 is subjected to initial crystallization using a bulk initializer. Then, a recording/reproduction test is executed. The layer structure of the phase change optical recording medium satisfies Rc<Ra and Ac>Aa. Rc exhibited a practical value of 5% or more. As a result, a value equal to or more than the recording/reproduction characteristic shown in FIG. 21 was obtained. Optical design that satisfied Rc>Ra and Ac>Aa could also be realized by selecting the materials and thicknesses of the respective layers and, more particularly, the respective dielectric layers.

The functions and effects of the phase change optical recording medium according to each embodiment, which has single-side, multiple recording layers (two layers), will be summarized below.

In a medium which has two phase change recording layers on one surface, the recording medium portion closer to the light incident side is called an L0 layer (first layer), and the recording medium portion far from the light incident side is called an L1 layer (second layer). An intermediate isolation layer made of a transparent resin and having a thickness of several ten μm is inserted between the L0 and L1 layers. The L0 layer is required to have a high transmittance of about 50% and a small transmittance difference between the amorphous state and the crystalline state. The L1 layer is required to have a high sensitivity. The medium of the present invention simultaneously satisfies both a high sensitivity and a small XE value. Hence, the layer structure of the present invention can be applied to the L1 layer, as is apparent from Popt in the above-described cases of the single recording layer. As is apparent from, e.g., FIG. 23, Popt ½ or less of the output of a blue semiconductor laser source is obtained. The L1 layer is generally formed by forming, on a pre-formatted substrate, the respective layers in an order reverse to that in a medium having a single-side, single recording layer, i.e., from a film on a side opposite to the light incident side to a film on the light incident side.

The present invention can also be effectively applied to the L0 layer of the medium having two phase change recording layers on one surface to simultaneously satisfy the high sensitivity and the small XE value. In the media shown in FIGS. 1, 3, 5, 7, 9, 11, 13, and 15, when the thickness of the phase change recording layer is about 5 to 7 nm, and the thickness of the reflecting layer is about 3 to 15 nm, an L0 layer having a transmittance of about 50% can be obtained. The present invention is useful even in such a medium having a thin recording layer.

A detailed example in which the present invention is applied to the LO layer will be described here. For example, a high-refractive-index layer, high-thermal-conductivity dielectric layer, high-refractive-index layer, interface layer, phase change recording layer, dielectric layer, semi-transparent reflecting layer, and high-thermal-conductivity dielectric layer are sequentially formed on an light-incident-side transparent substrate by sputtering. The high-refractive-index layer is made of a ZnS—SiO₂ layer having a thickness of 10 to 30 nm. The high-thermal-conductivity dielectric layer is made of an AlN layer having a thickness of 10 to 50 nm. The high-refractive-index layer s made of a ZnS—SiO₂ layer having a thickness of 10 to 30 nm. The interface layer is made of a CeO₂ layer having a thickness of 1 to 5 nm. The phase change recording layer is made of a Ge₄₀Sb₄Bi₄Te₅₂ layer having a thickness of 5 to 7 nm. The dielectric layer is made of a ZnS—SiO₂ layer having a thickness of 5 to 20 nm. The semi-transparent reflecting layer is made of an AgPdCu layer having a thickness of 3 to 15 nm. The high-thermal-conductivity dielectric layer is made of a BN layer having a thickness of 5 to 20 nm. After that, an L1 layer to which the structure of the above-described single-side, single recording layer according to one of the embodiments described above is applied (or an L1 layer to which the present invention is not applied) is bonded via an intermediate isolation layer. With this process, a single-side, two-layer phase change optical recording medium having L0 and L1 layers to which the present invention is applied can be formed. The characteristic of the obtained single-side, two-layer medium was checked while decreasing the linear velocity or track density by about 10% from that shown in FIG. 20. For both of the L0 and L1 layers, almost the same characteristic as that shown in FIG. 21 was obtained. Hence, it was found that the present invention was useful even for the single-side, two-layer phase change optical recording medium.

According to the present invention described above, the recording sensitivity of a phase change optical recording medium can be optimized. In addition, cross erase that poses a problem in a small track pitch can be greatly reduced. Hence, the storage capacity of phase change optical recording can be largely increased for both of single-side, one-layer recording and single-side, two-layer recording.

The essential effect of the present invention is to increase the track density by reducing cross erase. Hence, the present invention is not particularly limited to a medium having the conventional “Ac>Aa” structure in which the effect has already been confirmed. However, when the present invention is applied to a medium adjusted to Ac>Aa, the functions and effects of the present invention become more conspicuous.

The effects will be summarized below.

(1) In the phase change optical recording medium of the invention according to the first and second embodiments, at least two kinds of dielectric layers, i.e., a high-thermal-conductivity dielectric layer and low-thermal-conductivity dielectric layer are formed on the light incident side of the phase change recording layer. The thermal conductivity of the high-thermal-conductivity layer is higher than that of the low-thermal-conductivity layer by 10 times or more. With this structure, thermal conduction in the film thickness direction of the recording layer can be promoted, and cross erase can be reduced. The high-thermal-conductivity dielectric layer may be formed in contact with the recording layer. However, to ensure the recording sensitivity and overwrite durability, preferably, the low-thermal-conductivity layer represented by ZnS—SiO₂ is formed in contact with the recording layer, and the high-thermal-conductivity layer is formed on the light incident side. A transparent substrate may be arranged on the light incident side of the high-thermal-conductivity layer. Alternatively, a film such as a ZnS—SiO₂, SiO₂, ZrO₂, BaTiO₃, TiO₂, Y₂O₃, Cu₂O, CeO₂, HfO2, MgF₂, or CaF₂ film, a plasma polymer film having a C—H bond or C—F bond, an organic sputter film having a C—F bond, or an organic spin-coat film, which has a relatively low thermal conductivity, may be arranged. The high-thermal-conductivity film preferably contains at least one material selected from the materials shown in FIG. 17. In addition, the high-thermal-conductivity film preferably contains at least one material selected from SiC, WC, AlN, BN, BeO, GdB₄, TbB₄, TmB₄, and DLC (Diamond Like Carbon) as a material which has a high thermal conductivity κh of 100 (W/mK) or more and exhibits a sufficient XE reduction effect even when the thickness d is small. The first dielectric layer (high thermal conductivity) 2 also preferably contains at least one material selected from AlN, BN, and DLC as a material which has a sufficiently small extinction coefficient and easily exhibits a high transmittance even when the thickness is large even in sputtering and, more particularly, cold sputtering optimum for film formation for an optical disk.

The relationship between Rc and Ra and that between Ac and Aa are not particularly limited. Preferably, Ac>Aa is set by selecting low-thermal-conductivity film materials and thicknesses and high-thermal-conductivity film materials and thicknesses. Alternatively, Ac>Aa is preferably set by using a semi-absorbing film on the surface opposite to the light incident surface of the recording layer or using a semi-transparent film for a reflecting layer portion.

In the present invention, the dielectric layer indicates a film whose extinction coefficient (k) of the complex refractive index is substantially zero. However, k=0 need not always be satisfied as long as the dielectric layer is made of a transparent film material as an optical recording medium. The allowable value of k depends on the film thickness. A single layer having a transmittance of at least 80% and, more preferably, 90% or more can be used as the dielectric layer of the present invention.

In the present invention, the thermal conductivity (κ) essentially indicates κ of a thin film used in the phase change optical recording medium. However, the numerical range of κ is limited (condition (1)) to κ of a bulk described in the thermophysical property handbook on the basis of the results of various kinds of experiments conducted in the process to derive the present invention. When the materials used are specified, it can be determined whether the present invention is practiced.

The condition that the thermal conductivity (κh) of the high-thermal-conductivity dielectric layer is higher than the thermal conductivity (κ1) of the low-thermal-conductivity dielectric layer by 10 times or more is necessary for simultaneously satisfying a practical sensitivity and sufficiently small cross erase (XE) in practice at a predetermined linear velocity (the linear velocity determines the data transfer rate together with the shortest bit pitch and format efficiency). The linear velocity is a design item of an optical recording system or optical recording drive. When κh/κ1≧10 is satisfied in a practical linear velocity range and, for example, in a range from several m/s to several ten m/s, both the sensitivity and XE can be ensured. The appropriate ranges of κh and κ1 are determined in accordance with the linear velocity. For example, at a linear velocity of 5.6 m/s (corresponding to a data transfer rate of 35 Mbps, which is compatible with a high-definition moving image, at a shortest bit pitch or 0.13 μm/bit and a format efficiency of 82%), an appropriate value of κ1 is 0.01 to 10 (W/mK). Accordingly, an appropriate value of κh is 0.1 (W/mK) or more or 100 (W/mK) or more. As one of optimum examples, ZnS—SiO₂ is used for the low-thermal-conductivity dielectric layer. In this case, κ1 is about 0.5 (W/mK) An appropriate value of κh is 5 (W/mK) or more, preferably, 50 (W/mK) or more, and more preferably, 100 (W/mK) or more. When the linear velocity is higher, the appropriate values of κ1 and κh shift to the lower side. When the linear velocity is higher, the appropriate values of κ1 and κh shift to the higher side. In a linear velocity range of several m/s to several ten m/s, both the sensitivity and XE can be ensured when κh/κ1≧10 is satisfied. When the linear velocity changes, the sensitivity and XE can be adjusted by κh×d defined in condition (1) as well as the values of κ1 and κh themselves.

(2) In the phase change optical recording medium of the invention according to the third, fourth, and fifth embodiments, at least two kinds of dielectric layers having different refractive indices and a high-thermal-conductivity dielectric layer are formed on the light incident side of the recording layer. For at least two kinds of dielectric layers having different refractive indices and, more particularly, for a high-refractive-index layer, ZnS—SiO₂, TiO₂, Si₃N₄, Nb₂O₅, ZrO₂, or ZnO can be used. For a low-refractive-index layer, SiO₂, MgF₂, CaF₂, a plasma polymer film, or an organic spin-coat film can be used. As a characteristic feature, when at least two kinds of dielectric layers having different refractive indices are used, the degree of freedom in optical design is largely improved. The material of the high-thermal-conductivity film used in the second invention is preferably selected from those described in (1) above. The relationship between Rc and Ra and that between Ac and Aa are not particularly limited. Preferably, Ac>Aa is set by selecting materials and thicknesses of at least two kinds of dielectric layers having different refractive indices and high-thermal-conductivity film materials and thicknesses. Alternatively, Ac>Aa is preferably set by using a semi-absorbing film on the surface opposite to the light incident surface of the recording layer or using a semi-transparent film for a reflecting layer portion. The high-thermal-conductivity dielectric film can be inserted on the transparent substrate, between at least two kinds of dielectric layers having different refractive indices, or between the dielectric layer and the phase change recording layer. However, to ensure an appropriate recording sensitivity and overwrite durability, preferably, a low-thermal-conductivity film represented by ZnS—SiO₂ is formed in contact with the recording layer, and the high-thermal-conductivity film is formed on the light incident side. The remaining conditions are the same as in (1) described above. The most preferable embodiment will be described in (3) below.

(3) As an improved technique similar to the invention according to the fourth embodiment, the present inventors have already proposed a structure in Japanese Patent Application No. 2002-52111. In this structure, a semi-absorbing film and, typically, a high-thermal-conductivity metal film having a thickness of several ten nm or less are formed on the light incident side of the phase change recording layer of a medium that satisfies Rc<Ra and Ac>Aa. With this structure, thermal conduction in the film thickness direction is promoted, and cross erase is reduced. As the studies by the present inventors progressed, it was found that when a semi-absorbing film material is used on the light incident side of the recording layer, the recording sensitivity decreases. It was also found that when a polycrystalline metal film is used, noise increases due to the grain boundary. Then, it was found that when a high-thermal-conductivity dielectric layer is used in place of the semi-absorbing film, cross erase can be reduced without degrading the recording sensitivity and increasing noise. In addition, although the thickness of an semi-absorbing high-thermal-conductivity film is limited, that of a high-thermal-conductivity dielectric film is not particularly limited. Hence, when the thickness is increased, a more conspicuous cross erase reduction effect can be obtained. As an important feature of the invention according to the fourth embodiment, a high-thermal-conductivity dielectric layer is formed at a position close to the recording layer, where an especially conspicuous cross erase reduction effect can be obtained. Also taking the overwrite repetitive durability and high erase characteristic into consideration, for example, a ZnS—SiO₂ layer having a low thermal conductivity is formed on a light-incident-side transparent substrate as a dielectric layer having a refractive index different from that of the transparent substrate. For example, an SiO₂ layer which also has a low thermal conductivity but a large refractive index difference from the ZnS—SiO₂ layer is formed on the ZnS—SiO₂ layer in order to facilitate design of Ac>Aa. A high-thermal-conductivity dielectric layer as an important feature of the present invention and, e.g., a ZnS—SiO₂ layer to ensure the overwrite durability are formed on the SiO₂ layer. A recording layer may be formed directly on the ZnS—SiO₂ layer. Alternatively, a recording layer may be formed via a crystallization promoting layer having a thickness of several nm. When no crystallization promoting layer is used, a GeSbTe film substituted with, e.g., Bi or Sn is preferably used as the recording layer to ensure the erase efficiency. When a crystallization promoting layer is used, a non-substituted GeSbTe film may be used as the recording layer. As the crystallization promoting layer, GeN, HfO₂, CeO₂, or Ta₂O₅ is typically used. The material of the high-thermal-conductivity film is preferably selected from those described in (1) above. The remaining conditions are the same as in (1) described above.

(4) The invention according to the sixth embodiment is related to an improved technique of a medium disclosed in Japanese Patent Application No. 2002-86297 proposed by the present inventors. The structure aims at reducing cross erase of a medium that satisfies Rc>Ra and Ac<Aa. By also using an absorption index control layer or a semi-transparent reflecting layer, a cross erase reduction effect can be obtained even for a medium that satisfies Rc>Ra and Ac>Aa. In Japanese Patent Application No. 2002-86297, a dielectric layer between a recording layer and a reflecting layer is divided. A semi-transparent high-thermal-conductivity metal film having a thickness of ten-odd nm or less is inserted between the dielectric layers. With this structure, thermal conduction in the film thickness direction is promoted, and cross erase is reduced. As research and development by the present inventors progressed, it was found that when a semi-transparent high-thermal-conductivity metal film is employed, the recording sensitivity decreases, and noise increases, as in Japanese Patent Application No. 2002-52111 described above. Then, the present inventors have derived the present invention. In the invention according to the sixth embodiment, the high-thermal-conductivity dielectric layer can be inserted between the recording layer and the second dielectric layer, to the intermediate portion between the second dielectric layers (the second dielectric layer is divided into at least two parts), or between the second dielectric layer and the reflecting layer. In the most preferable structure, a crystallization promoting layer or, e.g., a ZnS—SiO₂ layer preferable for the overwrite durability is formed on the recording layer, due to the same reasons as described in (1) to (4) above. The high-thermal-conductivity transparent layer is formed on the crystallization promoting layer or ZnS—SiO₂ layer. The reflecting layer is formed directly on the high-thermal-conductivity dielectric layer or via a low-thermal-conductivity transparent layer (e.g., a ZnS—SiO₂ layer). The thermal conductivity of the high-thermal-conductivity layer is higher than that of the film material that has the lowest thermal conductivity in the second dielectric layer by 10 times or more. With this structure, thermal conduction in the film thickness direction of the recording layer can be promoted, and XE can be reduced. In addition, both the sensitivity and XE can be simultaneously satisfied in the practical linear velocity range, as described in the first invention.

(5) A phase change optical recording medium of this invention has both the structure of the invention (1), (2), or (3) and the structure of the invention (4). High-thermal-conductivity transparent films are formed on both the light-incident-side surface of a recording layer and the surface opposite to the light incident side. The material of the high-thermal-conductivity film is preferably selected from those described in (1) above.

This invention can be applied not only to a medium having a single-side, single recording layer but also to the L0 and L1 layers of a single-side, two-layered recording layer medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording medium comprising:
a substrate;
a reflecting layer which reflects a light beam;
a phase change recording layer which is arranged between the substrate and the reflecting layer and changes between a crystalline state and an amorphous state when irradiated with the light beam;
a first dielectric layer which is arranged between the substrate and the reflecting layer; and
a second dielectric layer which is arranged between the substrate and the first dielectric layer and has a thermal conductivity lower than that of the first dielectric layer.

2. A medium according to claim 1, wherein the first dielectric layer is arranged between the second dielectric layer and the phase change recording layer.

3. A medium according to claim 1, further comprising a dielectric layer which is arranged between the first dielectric layer and the phase change recording layer and has a refractive index different from that of the second dielectric layer.

4. A medium according to claim 1, wherein
the second dielectric layer includes a dielectric layer having a first refractive index and a dielectric layer having a second refractive index,
the medium further comprises a dielectric layer which is arranged between the first dielectric layer and the phase change recording layer and has a third refractive index, and
the first refractive index and the third refractive index are higher than the second refractive index.

5. A medium according to claim 1, further comprising
a third dielectric layer which is arranged between the first dielectric layer and the phase change recording layer and has a refractive index different from that of the second dielectric layer, and
a fourth dielectric layer which is arranged between the third dielectric layer and the phase change recording layer and has a refractive index different from that of the third dielectric layer.

6. A medium according to claim 1, wherein
the first dielectric layer is arranged between the phase change recording layer and the reflecting layer, and
the medium further comprises
a third dielectric layer which is arranged between the phase change recording layer and the first dielectric layer and has a thermal conductivity lower than that of the second dielectric layer, and
a fourth dielectric layer which is arranged between the first dielectric layer and the reflecting layer and has a thermal conductivity lower than that of the second dielectric layer.

7. A medium according to claim 1, wherein
the first dielectric layer is arranged between the phase change recording layer and the reflecting layer, and
the medium further comprises a third dielectric layer which is arranged between the first dielectric layer and the reflecting layer and has a thermal conductivity lower than that of the second dielectric layer.

8. A medium according to claim 1, wherein
the first dielectric layer is arranged between the phase change recording layer and the reflecting layer, and
the medium further comprises a third dielectric layer which is arranged between the phase change recording layer and the first dielectric layer and has a thermal conductivity lower than that of the second dielectric layer.

9. A medium according to claim 1, wherein a thermal conductivity κh (W/m·K) of the first dielectric layer at a thickness d (nm) and 300 (K) satisfies
1.5×10E-6(W/K)≦κh×d≦1.5×10E-5(W/K).

10. A medium according to claim 1, wherein the first dielectric layer essentially contains at least one material selected from the group consisting of SiC, WC, AlN, BN, BeO, GdB₄, TbB₄, TmB₄, DLC (Diamond Like Carbon), Si₃N₄, B₄C, TiC, MgO, ZnO, Al₂O₃, TiB₂, ZrB₂, and Si.
